(19) United States
(12) Patent Application Publication
(10) Pub. No.: US 2024/0377339 A1
(43) Pub. Date: Nov. 14, 2024

(54) SYSTEM AND METHOD FOR CABINET X-RAY IRRADIATOR SYSTEMS WITH CAMERA

(71) Applicant: KUB TECHNOLOGIES, INC. DBA KUBTEC, Stratford, CT (US)

(72) Inventors: Vikram Butani, Fairfield, CT (US); Chester Lowe, Palm Springs, CA (US); Karla Palma, Stratford, CT (US); Mustafa Merchant, Stratford, CT (US); Vivek Raut, Stratford, CT (US)

(73) Assignee: KUB TECHNOLOGIES, INC. DBA KUBTEC, Stratford, CT (US)

(21) Appl. No.: 18/534,590

(22) Filed: Dec. 9, 2023

Related U.S. Application Data
(60) Provisional application No. 63/464,848, filed on May 8, 2023.

(51) Int. Cl. G01N 23/04; G01N 21/17

(52) U.S. Cl. CPC G01N 23/04; G01N 21/17; G01N 2021/1765; G01N 2223/408; G01N 2223/6123; G01N 2223/6126

(57) ABSTRACT

The present disclosure relates to the field of a cabinet x-ray irradiator incorporating an x-ray tube and a real-time camera, either high definition or standard resolution, for the production of organic and non-organic images. The computing device can receive video data from the camera and determines, based on the video data, an overlay of the captured real-time image or display images adjacently i.e. Picture-In-Picture (PIP). In particular, the disclosure relates to a system and method with corresponding apparatus for capturing a real-time image simultaneously with the x-ray irradiation allowing a cabinet x-ray irradiation unit to attain and optimize images with exact orientation of the irradiated specimen.

### BACKGROUND

### Field of the Present Disclosure

The present disclosure relates to the field of a cabinet x-ray irradiator incorporating a system and method for incorporating a camera, either high definition or standard resolution, taking an optical image both live and static and displaying the resulting images.

### Background

Today, conventional cabinet x-ray irradiators do not have a way to visualize the sample placed into the cabinet once the door is closed.

With a unit incorporating a camera, the technician can utilize the resultant photo or optical image to expeditiously visualize the specimen and verify that it is situated properly within the sample chamber.

Cabinet X-ray Irradiators are considered the optimal replacement for live-source irradiators and with the incorporation of a video link and/or option that can be displayed on the control console monitor it would expedite and verify that the specimen being irradiated is located properly.

### SUMMARY

The present disclosure relates to the field of a cabinet x-ray irradiator incorporating an x-ray tube and a real-time camera for the production of organic and non-organic specimen images of the specimen placed into the irradiation chamber. The computing device receives video data from the real-time camera and displays the orientation of the specimen, based on the video data, with the captured real-time image or display an adjacent image i.e. Picture-In-Picture (PIP). This facilitates and aids the technician in ensuring that the proper location of the specimen whether it be organic or non-organic. In particular, the disclosure relates to a system and method with corresponding apparatus for capturing a real-time image allowing a cabinet x-ray irradiator unit to attain and optimize images or the specimen once the cabinet door is closed.

In one embodiment, the aspects of the present disclosure are directed to a system and method including a cabinet x-ray irradiator system incorporating a real-time camera. This embodiment includes a cabinet x-ray system, a base unit including an image processor and a display, including an x-ray source, a system configured to receive video data and an interface for enabling an analog/digital signal to be transferred from an image capture apparatus to the image processor of the base unit. The system may be further be configured to supply standard or high-definition (HD) real-time images. A camera can be used to receive video data and may be digital to provide electronic images. The cabinet x-ray irradiator system may concurrently capture a real-time image. The camera may be mounted onto the system so as to integrate an exact capture/orientation image of the sample being irradiated. The unit may be enclosed in a cabinet x-ray system. The unit may be utilized for excised tissue, organ or bone specimens. The unit may be utilized for any organic or inorganic specimen that fits inside the system framework or x-ray cabinet. The image capturing mechanism may be mounted in a cabinet x-ray irradiator system, such as the cabinet system illustrated in the embodiment shown in FIG. 1. The real-time image can be displayed or overlaid onto the program (Picture-in-Picture-PIP).

In another embodiment, the aspects of the present disclosure are directed to a computing device including at least with one processor and at least one display unit operable by the at least one processor. The at least one display unit operable by the at least one processor is configured to output, for display, determining, based on the video data, a display action and be responsive to determining the preference/initiated action, output for display the resultant images attained by the x-ray irradiator cabinet system.

In another embodiment, the aspects of the present disclosure are directed to a cabinet x-ray irradiator and optical camera system for obtaining an optical image of a specimen both before and while it is being irradiated. The cabinet x-ray irradiator and optical camera system includes a cabinet defining an interior chamber, a display, an x-ray system, an optical camera and a controller. The x-ray system includes an x-ray source and a specimen platform. The optical camera is configured to capture an optical image of the specimen. The controller is configured to selectively energize the x-ray source to emit x-rays through the specimen to irradiate, control the optical camera to capture and collect the optical image of the specimen and selectively display the optical image on the display.

In another embodiment, the aspects of the present disclosure are directed to a method for performing an optical image of a specimen in a cabinet x-ray irradiator and optical image system, processing and displaying the optical image of the specimen. The cabinet x-ray and optical image system includes a cabinet defining an interior chamber, a display, an x-ray system, and optical camera and a controller. The x-ray system includes an x-ray source and a specimen platform. The optical camera is configured to capture an optical image of the specimen. The controller is configured to selectively energize the x-ray source to emit x-rays through the specimen to perform irradiation, control the optical camera to capture and collect the optical image of the specimen and selectively display the optical image on the display. The method includes controlling the x-ray system to irradiate the specimen when the x-ray source is energized, controlling the optical camera to capture and collect the optical image of the specimen and selectively displaying the optical image on the display.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To further clarify the above and other advantages and features of the present disclosure, a more particular description of the disclosure will be rendered by reference to specific embodiments thereof that are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1—Schematically illustrates a front view of an X-ray Irradiation source, a specimen/sample, and a sample tray

FIG. 2—illustrates an exemplary workflow/flowchart of an aspect of the disclosed embodiments.

FIG. 3—illustrates an example of an X-ray Cabinet System incorporating aspects of the present disclosure.

FIG. 4—illustrates an interconnection diagram of an HD camera embodiment that may be utilized in aspects of the disclosed embodiments of the present disclosure;

### DETAILED DESCRIPTION

In general, aspects of this disclosure include a device (cabinet x-ray irradiator system) utilizing a camera to capture an optical image (in black and white, gray scale or color, preferably color), preferably in real-time, of a sample or specimen also being irradiated.

The photo/captured camera optical image, preferably in real-time, may be displayed on the monitor either overlaid onto the program on the monitor of the sample or as back to back viewing on a monitor between two images or a side-by-side or Picture-In-a-Picture (PIP) displayed adjacent to the program. A device capturing an optical image, preferably in real-time, of the specimen facilitates confirmation and orientation for the technician.

A preferred embodiment system would be to incorporate an HD (high-definition) optical camera into a cabinet x-ray irradiator unit allowing the system to capture an HD optical image so obtained can be displayed as disclosed herein.

The present disclosure and embodiments included therein can relate to specimen irradiation but the disclosure is not isolated to specimen irradiation but may be utilized, for irradiation of organic and non-organic samples or specimens, requiring a cabinet x-ray irradiation system but is not limited to just an HD camera but to any camera fitting within the confines of the cabinet x-ray system.

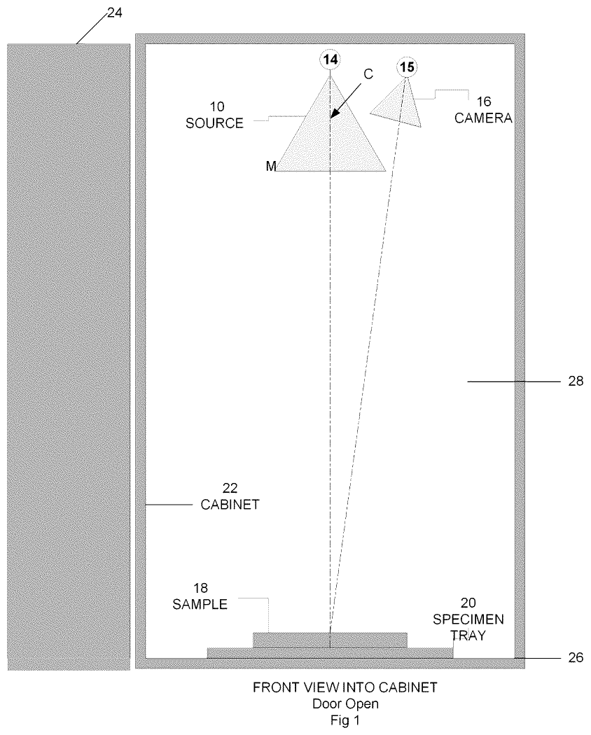

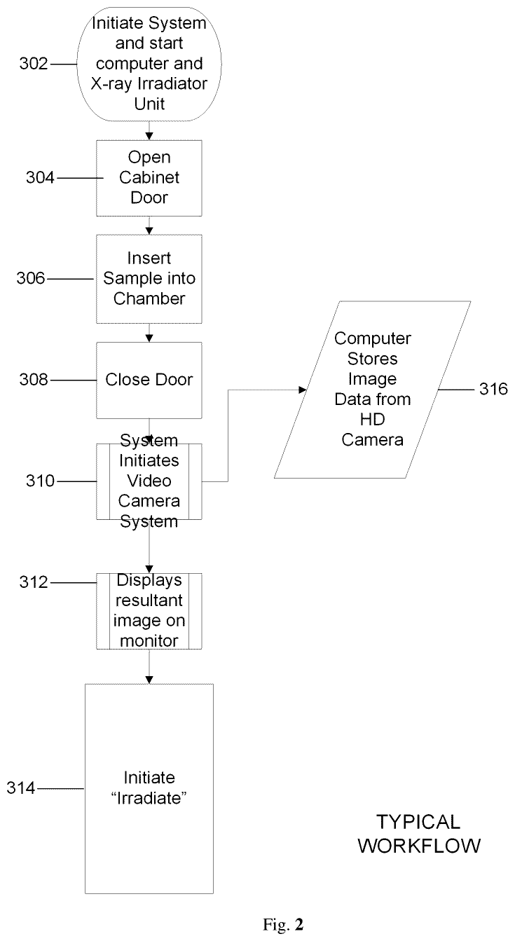

Reference will now be made to figures wherein like structures will be provided with like reference designations. It is understood that the drawings are diagrammatic and schematic representations of exemplary embodiments of the disclosure and are not limiting of the present disclosure nor are they necessarily drawn to scale. FIGS. 1-4 depict various features and uses of embodiments of the present disclosure, which embodiments are generally directed to a system that can utilize an optical camera, preferably an HD or similar real-time camera, to capture an image of the specimen/sample concurrently with the x-ray irradiation

The systems and methods of embodiments of the present disclosure also address unmet needs by providing apparatus and techniques that include optical imaging for imaging specimens that overcome the shortfall of the data received from other cabinet irradiation systems alone.

As used herein, the term “computer,” “computer system”, or “processor” refers to any suitable device operable to accept input, process the input according to predefined rules, and produce output, including, for example, a server, workstation, personal computer, network computer, wireless telephone, personal digital assistant, one or more microprocessors within these or other devices, or any other suitable processing device with accessible memory.

The term “computer program” or “software” refers to any non-transitory machine-readable instructions, program or library of routines capable of executing on a computer or computer system including computer readable program code.

The terms “camera” or “optical camera” refer to an instrument, including an optical instrument for capturing images in black and white, gray scale or color (preferably color) using reflected and/or emitted wavelengths of the electromagnetic spectrum, for example, visible light or fluorescent light, from an object, similar to a photograph or that which could be viewed by a human eye, using an electronic light-sensitive sensor array. These terms may include such instruments producing images in standard resolution or HD as well as a digital camera that can directly capture and store an image in computer-readable form using an array of electronic light-sensitive elements—typically semiconductor photo-sensors—that produce a light-intensity-dependent electronic signal in response to being illuminated.

Reference will now be made to figures wherein like structures will be provided with like reference designations. It is understood that the drawings are diagrammatic and schematic representations of exemplary embodiments of the disclosure and are not limiting of the present disclosure nor are they necessarily drawn to scale.

Specimen tomography is a three-dimensional specimen imaging system. It involves acquiring images of a sample at multiple viewpoints, typically over an arc or linear path. The three-dimensional image is constructed by the reconstruction of the multiple image data set.

FIG. 1 schematically illustrates one embodiment of the orientation of the X-ray source 10 as seen when the door 24 is opened and the X-ray source 10 is locate at approximately 0°, reference point 14 in this example, within the X-ray cabinet 22. In this embodiment, the motion of the X-ray source 10 can generally occur from the back to the front of the X-ray cabinet 22 with the specimen tray 20 oriented, or otherwise disposed, at the base 26 of the X-ray cabinet 22,

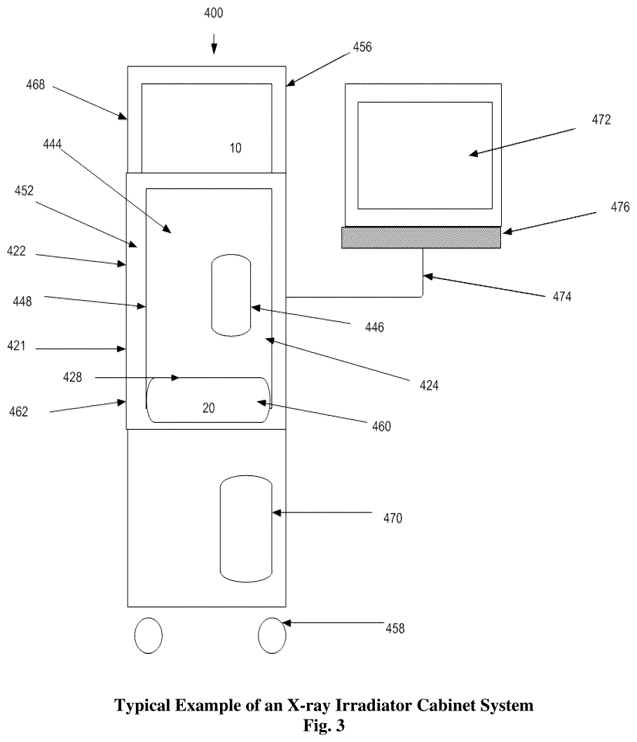

FIG. 3 illustrates one embodiment of an exemplary workflow from initiating 302 the system 100 through irradiation, and display 324 of data images collected of the sample 18.

As will be generally understood, the system 100 is initiated 302, the X-ray cabinet door 24 opened 304, and the sample 18 placed into 306 the X-ray cabinet chamber 28. As shown in FIG. 1, for example, the sample 18 is positioned on the sample tray 20 in a suitable manner. The door 24 is closed 308.

The data and information regarding the sample 18, including any other suitable information or settings relevant to the irradiation process and procedure, is entered 310 into the computer 470. The irradiation is initiated 312. The system 100 will capture 316 images.

The captured images are stored 318 and then displayed 324 in real-time

FIG. 3 shows one embodiment of an X-ray Cabinet System 400 incorporating aspects of the present disclosure. In this embodiment, the X-ray Cabinet System 400 is mounted on wheels 458 to allow easy portability. In alternate embodiments, the X-ray Cabinet System 400 can be mounted on any suitable base or transport mechanism. The cabinet 422 in this example, similar to the exemplary X-ray cabinet 22 of FIG. 1, is constructed of a suitable material such as steel. In one embodiment, the cabinet 422 comprises painted steel defining a walled enclosure with an opening or cabinet chamber 428. Within the cabinet chamber 428, behind door 424, resides an interior space forming a sample chamber 444, which in this example is constructed of stainless steel. Access to the sample chamber 444 is via an opening 446. In one embodiment, the opening 446 of the sample chamber 444 has a suitable door or cover, such as a moveable cover 448. In one embodiment, the moveable cover 448 comprises a door which has a window of leaded glass.

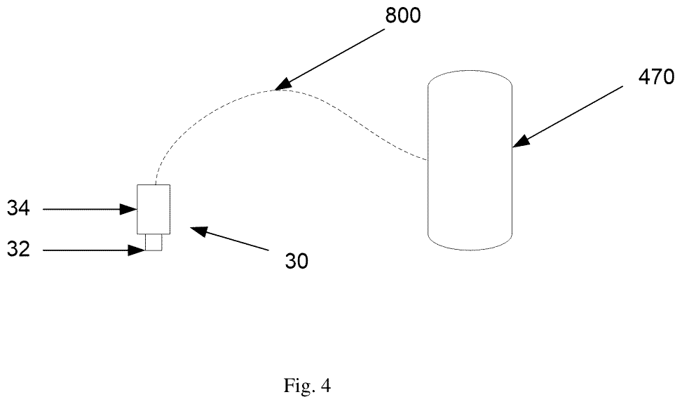

Between the outer wall 421 of cabinet 422 and the sample chamber 444 are sheets of lead 452 that serve as shielding to reduce radiation leakage emitted from the X-ray source 10. In the example of FIG. 4, the X-ray source 10 is located in the upper part 456 of the cabinet 422, in the source enclosure 468. The sample tray 20 is housed in the detector enclosure 460 at an approximate midpoint 462 of the cabinet 422.

The computer 470 receives commands and other input information entered by the operator via a user interface 476, such as a keyboard and mouse for example. In one embodiment, the computer 470 can comprise a touch screen or near touch screen device. Although the aspects of the disclosed embodiments will generally be described with respect to a computer 470, it will be understood that the computer 470 can comprise any suitable controller or computing device. Such computing devices can include, but are not limited to, laptop computers, mini computers, tablets and pad devices.

The computer 470 can be configured to communicate with the components of the X-ray cabinet system 400 in any suitable manner, including hardwired and wireless communication. In one embodiment, the computer 470 can be configured to communicate over a network, such as a Local Area Network or the Internet.

Referring to FIG. 4, there is shown the interconnection of an embodiment of a camera 30 incorporated into a Cabinet X-Ray Unit which connects to and can be controlled by the computer 470 via cable 800 including, for example a USB cable. Other wireless formats for communication between camera 30 and computer 470 can also be used in embodiment of the present disclosure. Camera 30 may include an optical lens assembly 32 through which an optical image passes and is focused upon an electronic light-sensitive sensory array included in the camera body 34. The optical image can then be sent using an electronic signal from the sensory array to the computer 470 via cable 800 or other wireless formats. The optical image can also be stored in the computer 470 for future examination and viewing, including storage in memory (e.g., RAM) or a disc recording medium (e.g., CD, DVD, etc.)

Camera 30 is included in FIG. 1 as well showing embodiments in camera 30, for example, located at position 15 in the cabinet x-ray unit such that it is capable of capturing a visual image of sample 18 in cabinet 22 and x-ray cabinet chamber 28 in FIG. 1 and in cabinet 422

In the systems and methods included in this disclosure as well as the embodiments disclosed herein, the resulting optical camera images can be displayed each alone or together as overlaid together, adjacent or PIP (Picture-in-Picture) on the monitor FIGS. 4-472. This, in turn, provides more flexibility for a clinician or other user of the system and simplifies the procedure. The separate images from the camera can be stored in the computer hard drive on the system 470 or a separate memory device, such as for example, a separate hard drive, flash drive, CD-ROM, DVD, etc. for future analysis. The camera can capture a visible light or other electromagnetic wavelength reflected or emitted by the sample or portions thereof, for example, though the use of fluorescent or other markers using a suitable light source where required. Manual input for operation of the cabinet x-ray unit may be initiated via keyboard or monitor touch screen and the resulting image from both the manual-initiated examination can be displayed on the screen and configured in accordance with one example embodiment of the present disclosure.

Indeed, it is appreciated that the system and its individual components can include additional features and components, though not disclosed herein, while still preserving the principles of the present disclosure. Note also that the base computer can be one of any number devices, including a desktop or laptop computer, etc.

Aspects of the present disclosure may be embodied in other specific forms without departing from its spirit or essential characteristics. The described embodiments are to be considered in all respects only as illustrative, not restrictive. All changes that come within the meaning and range of equivalency of the claims are to be embraced within their scope.

1. A cabinet x-ray irradiator and optical camera system for performing x-ray irradiation and optical images of a specimen, the system comprising:
a cabinet defining an interior chamber;
a display;
an x-ray system including:
an x-ray source;
and
a specimen platform;
an optical camera configured to capture an optical image of the specimen; and
a controller configured to:
selectively energize the x-ray source to emit x-rays and irradiate through the specimen;
control the optical camera to capture and collect the optical image of the specimen; and
selectively display the optical image on the display.

2. The cabinet x-ray irradiator and optical camera system of claim 1, wherein the cabinet comprises a walled enclosure surrounding the interior chamber, a door configured to cover the interior chamber and a sampling chamber within the interior chamber for containing the specimen.

3. The cabinet x-ray irradiator and optical camera of claim 1, wherein the specimen platform is configured for excised tissue, organ or bone specimens.

4. The cabinet x-ray irradiator and optical camera system of claim 1, wherein the specimen platform is configured for any organic or inorganic specimen that fits inside an x-ray cabinet.

5-6. (canceled)

7. The cabinet x-ray irradiator and optical camera system of claim 1, wherein the orientation of the specimen the optical image are substantially the same.

8. The cabinet x-ray irradiator and optical camera system of claim 1, wherein the controller is configured to selectively display the optical image on the display simultaneously side-by-side or picture-in-a-picture.

9. The cabinet x-ray and optical camera system of claim 1, wherein the controller is configured to selectively display the optical image on the display overlaid.
